(19) United States
(12) Patent Application Publication
(10) Pub. No.: US 2005/0072867 A1
(43) Pub. Date: Apr. 7, 2005

(54) Method and system of unloading contents of a container

(75) Inventors: Clinton David Pinner Burleigh, Marsfield (AU); Brian Leslie Watson, West Meadows (AU)

Correspondence Address: NIXON & VANDERHYE, PC, 1100 N GLEBE ROAD, 8TH FLOOR, ARLINGTON, VA, 22201-4714, US

(73) Assignees: CONTROL AUTOMATION PTY LTD, West Heidelberg (AU); KOCKUMS BULK SYSTEMS PTY LTD, West Heidelberg (AU)

(21) Appl. No.: 10/665,353

(22) Filed: Sep. 22, 2003

(51) Int. Cl. A01C 3/06; A01C 7/08

(52) U.S. Cl. 239/650

(57) ABSTRACT

Apparatus for preparing for the unloading of contents of a container comprising a frame for receiving the container, a funnel having an end for attachment to an opening of the container, the funnel having a valve located adjacent an opposite end of the funnel, whereupon securing the funnel and container to the frame, a portion of the frame is able to rotate the funnel and container through a predetermined angle to place the funnel and container in a position ready for partial or full discharge of the contents through the funnel and valve. There is also disclosed apparatus for rotating a load.

### FIELD OF THE INVENTION

This invention relates to a method and apparatus for unloading the contents of a container and to a method and apparatus for rotating a load.

### BACKGROUND TO THE INVENTION

Collapsible containers exist that have a capacity generally of between 1 and 1.5 cubic metres and are capable of transporting up to 1.5 tonnes of product. Such collapsible containers are presently used to store and transport liquid and free flowing granular products that exit from the container easily, such as in a pouring fashion. The containers are able to be collapsed to about one third of the overall height of the uncollapsed form for freighting back to the source of the product.

The collapsible containers have been used to store and transport fine and cohesive powders, however due to the condensed and tightly packed nature of the powder in the containers, previous attempts by the container suppliers to unload the containers have failed. As a result of the high packing density of the powder it is difficult to remove the powder from the container as it generally clumps together or to the sides of the container. Such removal of the powder is preferably in such a way that air does not come into contact with the powder during the unloading or loading stage.

Intermediate bulk containers or IBCs have been in use for many years to transport powder around particular plants or from one destination to another. Generally the IBCs have a cone at their base within which is located a smaller inverted cone valve. When the valve is lifted on a discharge station by for example a probe, the powder is released from the container and is fed to the discharge station or to a process below such as another container, outlet or pipe. When the cone valve is lowered the IBC may be removed from the station and stored in a partially emptied or emptied state.

Coarse metering directly from the IBC is possible using automated features of the cone valve. However the problems with using IBCs is essentially their bulk for either storing powder or particulate matter or transporting the powder or particulate matter. They require specific equipment in order to unload the contents therefrom and there is no relatively easy manner in which such a process of unloading is possible.

The present invention provides a system and method for removing a product, such as a powder or granular material, from collapsible containers in a more improved and efficient manner than previously attempted.

### SUMMARY OF THE INVENTION

According to a first aspect of the invention there is provided a method of preparing for the unloading of contents of a container comprising the steps of:
attaching one end of a funnel means to an opening of the container, the funnel means having valve means located adjacent an opposite end of the funnel means;
rotating the funnel means and container through a predetermined angle using a frame; and
removing the funnel means and container from the frame ready for partial or full discharge of the contents through the funnel means and valve means.

The step of attaching the funnel means to the container may include the step of clamping the periphery of the one end of the funnel means, using clamp means, to the opening of the container, preferably to a lip around the periphery of the opening of the container.

Prior to the attaching step the method may further comprise the step of raising the container to a position such that the opening of the container contacts the end of the funnel means.

The rotating step may be as a result of a shaft being connected to a portion of the frame which is rotated via a motor. After the funnel means and container have rotated through the predetermined angle, the container may be detached from the frame.

Preferably the predetermined angle is about 180 degrees.

According to a second aspect of the invention there is provided apparatus for preparing for the unloading of contents of a container comprising:
a frame for receiving the container;
a funnel means having an end for attaching to an opening of the container, the funnel means having valve means located adjacent an opposite end of the funnel means;
whereupon securing the funnel means and container to the frame, a portion of the frame is able to rotate the funnel means and container through a predetermined angle to place the funnel means and container in a position ready for partial or full discharge of the contents through the funnel means and valve means.

The frame may comprise a base portion and a rotatable portion that rotates within the base portion. The container may be initially loaded into the rotatable portion of the frame, by suitable means such as a forklift, in a position below the end of the funnel means, which is preferably attached to a first member of the rotatable portion. The apparatus may further include means for raising the container such that the opening of the container is brought into contact with the end of the funnel means. Preferably the raising means is a pair of cylinders, preferably pneumatic cylinders. Each cylinder in the pair may be attached to the rotatable portion of the frame.

The apparatus may further comprise means for attaching the funnel means to the opening of the container. The attaching means may be in the form of clamps located adjacent the periphery of the end of the funnel means and attachable to a lip around the periphery of the opening of the container.

A motor attached to the base portion may drive or rotate a shaft which is connected at a distal end to the rotatable portion of the frame in order to rotate the rotatable portion and thereby rotate the funnel means and container.

Once the funnel means and container have been rotated through the predetermined angle, the raising means may be activated to release the container from the rotatable portion of the frame. Preferably the predetermined angle is about 180 degrees.

The container may then be removed from the frame by suitable means, such as a forklift, and transported for storage or to a processing station ready for removal of part or all of the contents of the container. The funnel means may be in the form of a truncated cone.

According to a third aspect of the invention there is provided a method of rotating a load, positioned on a first load support means, comprising the steps of:
placing the load into a frame;
securing the load to a second load support means;
rotating a portion of the frame through a predetermined angle such that the second load support means fully supports the load;
removing the load and second load support means from the frame ready for transport to an uncontaminated environment; and
wherein the first load support means is prevented from entering the uncontaminated environment.

According to a fourth aspect of the invention there is provided apparatus for rotating a load, positioned on a first load support means, comprising:
a frame for receiving the load and the first load support means;
wherein a second load support means is secured to the load;
wherein further a portion of the frame is able to rotate through a predetermined angle until the second load support means fully supports the load;
wherein subsequently the load and second support means are removed from the frame ready for transport to an uncontaminated environment and the first load support means is prevented from entering the uncontaminated environment.

### BRIEF DESCRIPTION OF THE DRAWINGS

Preferred embodiments of the invention will hereinafter be described, by way of example only, with reference to the accompanying drawings in which:

FIG. 1 is a side view of a container about to be loaded into apparatus according to a first embodiment of the invention;

FIGS. 2A and 2B are respectively front and side views of the apparatus shown without the container loaded therein;

FIGS. 3A and 3B are respectively front and side views of the apparatus showing the container in a raised state and attached to a funnel means;

FIG. 4 is a side view showing a portion of a frame of the apparatus, the container and the funnel means, in the form of a truncated feed cone, being rotated through an angle;

FIGS. 5A and 5B are respective front and side views showing the frame portion, funnel means and container rotated approximately 180 degrees from their respective positions shown in FIGS. 3A and 3B;

FIGS. 6A and 6B are respective front and side views of the apparatus showing the container and funnel means in a lowered position detached from a frame member;

FIG. 7 is a side view of the container and funnel means being transported after removal from the frame;

FIG. 8 is a side view of a load about to be loaded into apparatus according to a second embodiment of the invention;

FIGS. 9A and 9B are respectively front and side views of the apparatus according to the second embodiment shown with the load placed therein;

FIGS. 10A and 10B are respectively front and side views of the apparatus of the FIGS. 9A and 9B shown with a gate securing access to the load;

FIGS. 11A and 11B are respectively front and side views of the apparatus according to the second embodiment showing the load in a raised state between first and second load support means and linked to a clamping means;

FIG. 12 is a side view showing a portion of a frame of the apparatus according to the second embodiment and the load being rotated through an angle;

FIGS. 13A and 13B are respective front and side views showing the frame portion and load rotated approximately 180 degrees from their respective positions shown in FIGS. 11A and 11B;

FIGS. 14A and 14B are respective front and side views of the apparatus according to the second embodiment showing the load in a lowered position detached from a frame member; and

FIG. 15 is a side view of the load and second load support means being transported after removal from the frame.

### DETAILED DESCRIPTION OF THE PREFERRED EMBODIMENTS

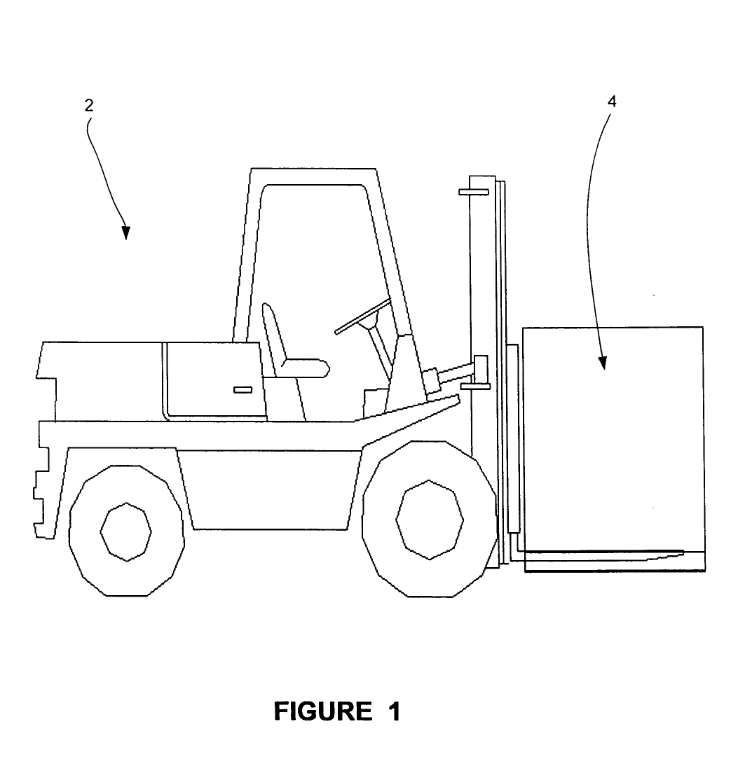

Shown in FIGS. 1 through to 7 is a sequence of views of a container being inverted to enable easy egress of its contents into a further process, such as via a chute, tube or another container.

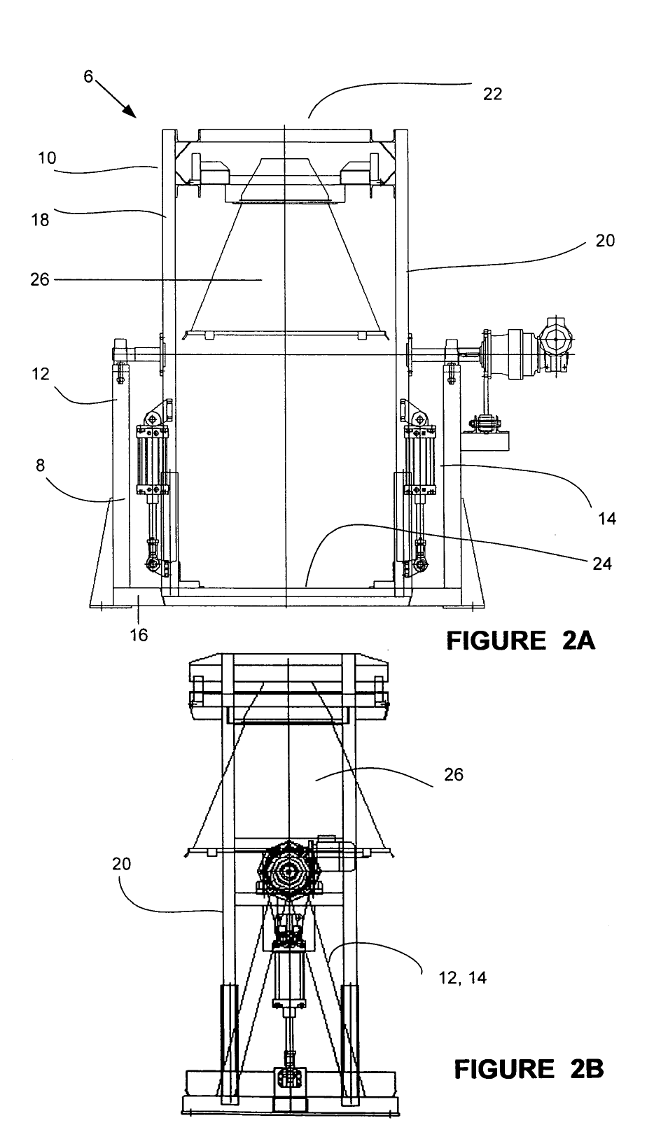

With reference to FIG. 1 there is shown a forklift 2 transporting a container 4, containing powder or granulated material for example, towards a structure or frame 6 that enables the rotation of the container 4. Referring to FIGS. 2A and 2B the frame 6 has a base portion 8 and a rotatable portion 10 that rotates under the action of a motor within the base portion 8. The base portion 8 is substantially constructed in a U-shape configuration as seen from the front in FIG. 2A having a pair of upright portions 12 and 14 and a bottom portion 16. When rotated through 90° the upright portions 12 and 14 of the base portion 8, as clearly seen in FIG. 2B, are ideally constructed as an inverted V shape. The portion 10 that rotates within the base portion 8 has generally two side members 18 and 20, a top member 22 and a lower member 24. Each of the top member 22 and bottom member 24 provide access to the tines of the forklift 2 to facilitate easy installation and removal of the container 4 from the frame 6.

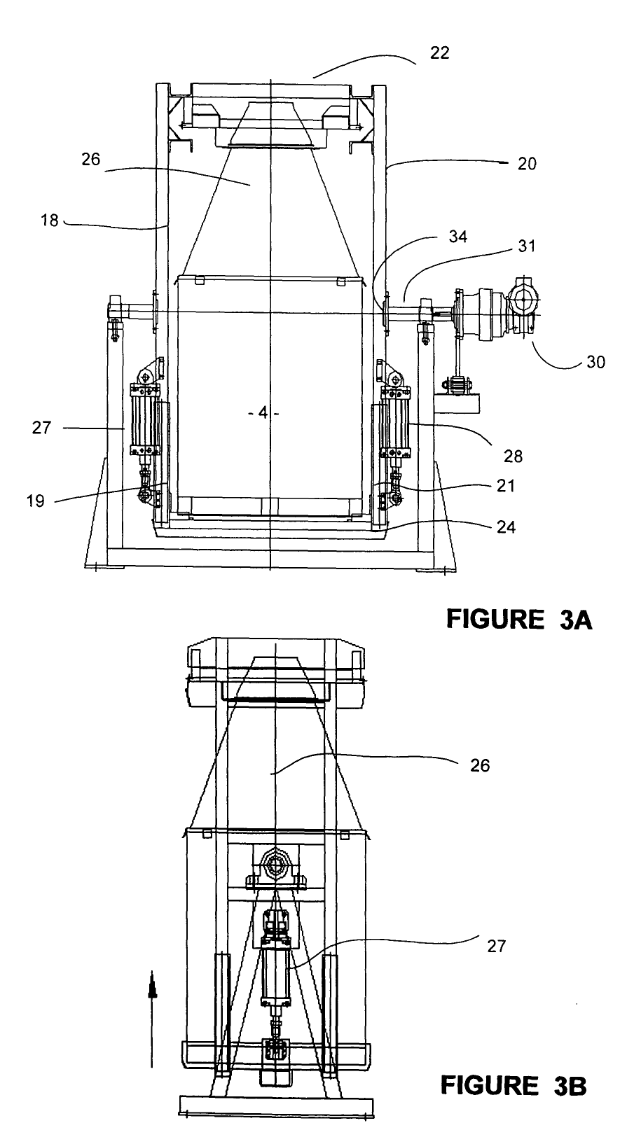

Suspended from the top member 22 of rotatable portion 10 is a funnel means 26, commonly called a feed cone which is shown in FIG. 2A as being truncated and in an inverted position. With reference to FIGS. 3A and 3B the forklift 2 has already positioned the container 4 within the portion 10 of the frame 6. The container 4 is positioned beneath the feed cone 26 with its lower periphery, surrounding the larger open end of the cone, substantially mating with the top or open end of the container 4. Prior to placing the container 4 within the frame 6 the top of the container 4 is removed, and if any intervening cover or sheet is positioned over the powder this is removed as well so that the feed cone 26 can fully engage the open end of the container 4 and therefore its contents. The container 4 is then moved in an upward direction to fully engage the lower section of the feed cone 26. This is performed typically by a pair of air cylinders 27, 28 each having one end respectively attached to bottom member 24 and an opposite end respectively attached to side members 18 and 20. Sleeves 19 and 21 attached to the bottom member 24 of rotatable portion 10 cover lower sections of upright portions of side members 18 and 20, the sleeves 19 and 21 being able to slide up or down over respective upright portions of side members 18 and 20. Shown in FIGS. 3A and 3B are a pair of upright portions that each form part of side members 18 and 20 and a pair of sleeves 19 and a separate pair of sleeves 21. Thus the sleeves simultaneously move over their corresponding upright portions. The activation of the air cylinders is performed manually by depressing a switch. The action of the cylinders 27, 28 moves each of the pairs of sleeves 19 and 21 over the upright portions of side members 18 and 20 to in turn move the bottom member 24 either closer to or further apart from the top member 22, depending on the direction of actuation of the cylinders 27, 28. Thus, once the cylinders have brought the container 4 into engagement with the lower portion of the feed cone 26 a number of latches or clamps (not shown) positioned around the outer portion of the feed cone 26 are securely attached to the rim around the open end of the container 4.

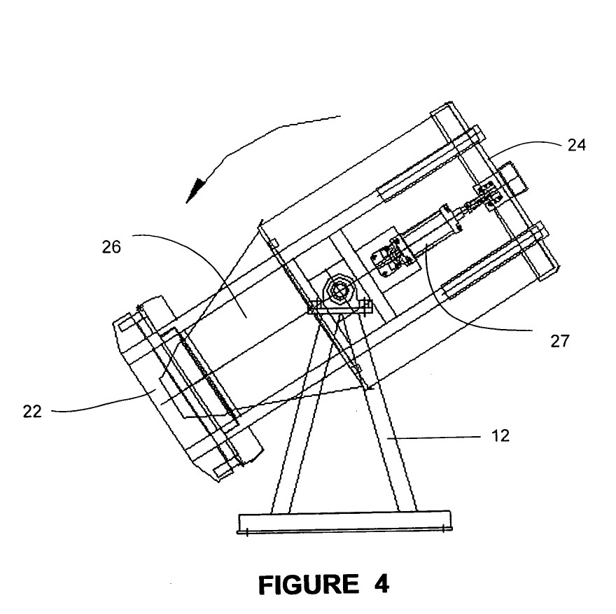

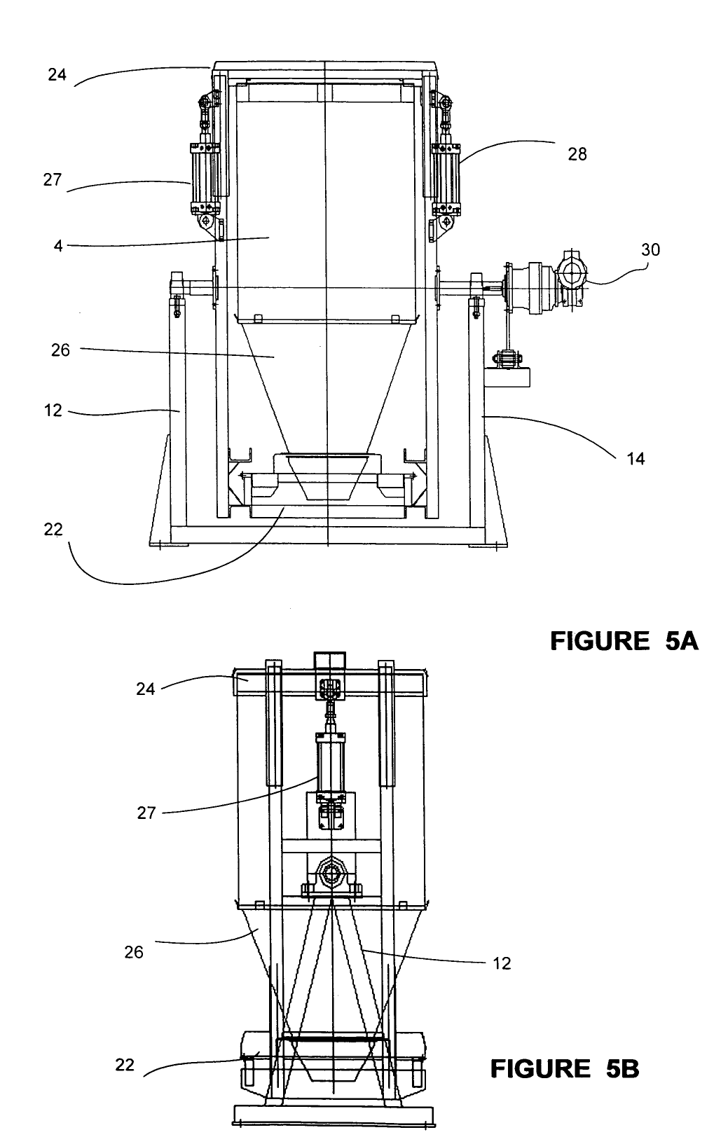

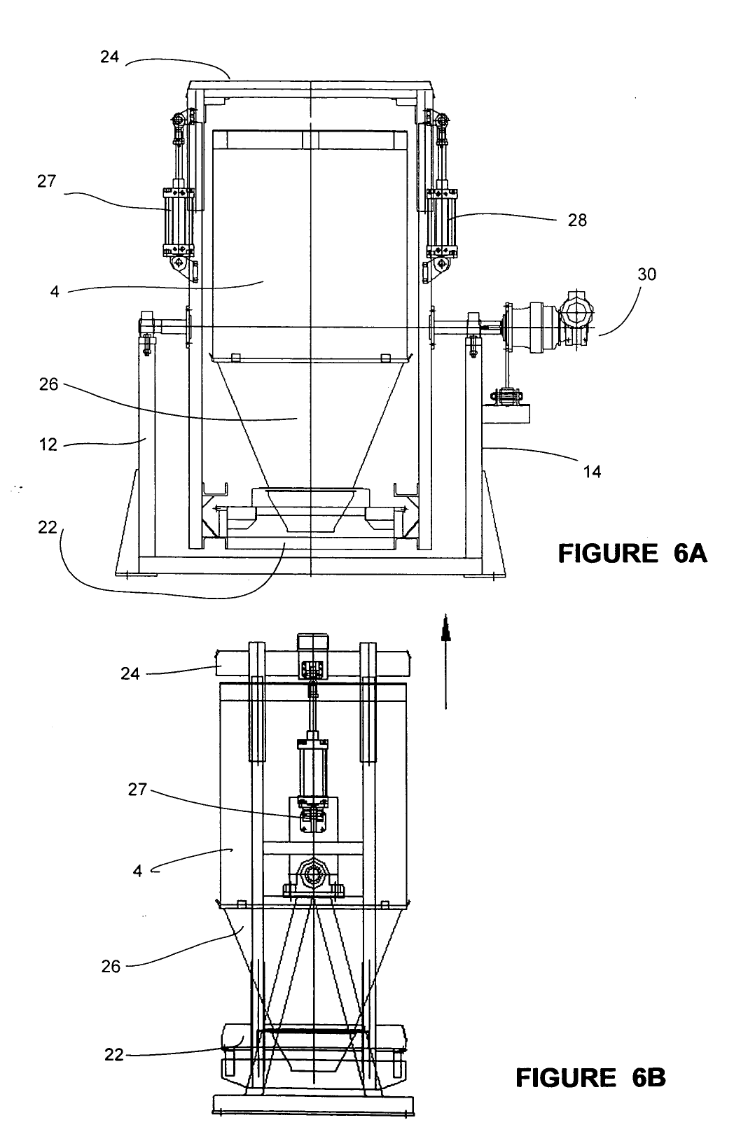

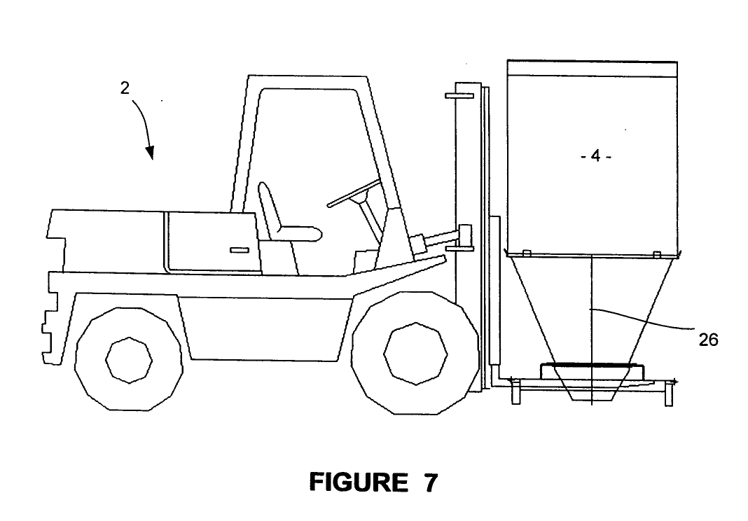

Upon activation of a further switch performed manually by an operator, a motor and gear box arrangement 30 is brought into action which has a shaft 31 connected to an end plate 34 which in turn is connected to a portion of the side member 20 of the rotatable portion 10. Thus on rotation of the shaft 31 the whole member 10 is rotated 180° as is shown in FIG. 4 so that with reference to FIGS. 5A and 5B the feed cone 26 is in an upright position ready to receive and direct the contents of the container 4 into a further process. With reference to FIGS. 6A and 6B, the direction of the air cylinders 27, 28 is reversed such that they detach the bottom member 24 of the unit 10 from the base of the container 4. This frees the combined container and feed cone 26 to enable removal from the member 10. Shown in FIG. 7 such removal is done simply by a forklift 2 undertaking the reverse process, as shown in FIG. 1, of loading the container 4. The container and feed cone together are then able to be transported to another section of a warehouse for example either for storage or to another process where part of the contents of the container 4 is removed. The feed cone 26 has located at its lower section a valve, called a cone valve which could also be of the type butterfly, iris, or slide gate which may use aerator assistance for discharge of the contents. A T-bar is generally used to hold the cone valve in place. When part or all of the contents needs to be emptied into another process or for example another container or outlet, as mentioned previously in relation to IBC containers, the valve is placed onto a discharge station over a probe and the upright movement of the probe against the valve releases the valve so that the contents can pass through the aperture that the valve was initially covering. The probe may vibrate or shake the cone valve to assist in removal of the cohesive powder or particulate material.

In a further embodiment the same process may be used to remove a first load support means such as a pallet or other supporting means that supports a load such as a stack of secured boxes or the like. Many food processing/preparation plants and pharmaceutical plants require removal of a base or pallet that is used to transport a load of bags/boxes from a particular supplier. The reason being that the particular pallet used to support and freight the load of bags/boxes into the facility is contaminated and any items coming into a food or pharmaceutical environment must be clean or uncontaminated. Thus the old non-sterile pallet (first load support means) is removed and replaced with a clean and uncontaminated pallet (second load support means) to further transport the loaded boxes or bags etc. Thus contamination entering a downstream process is prevented by the removal of the non-sterile pallet.

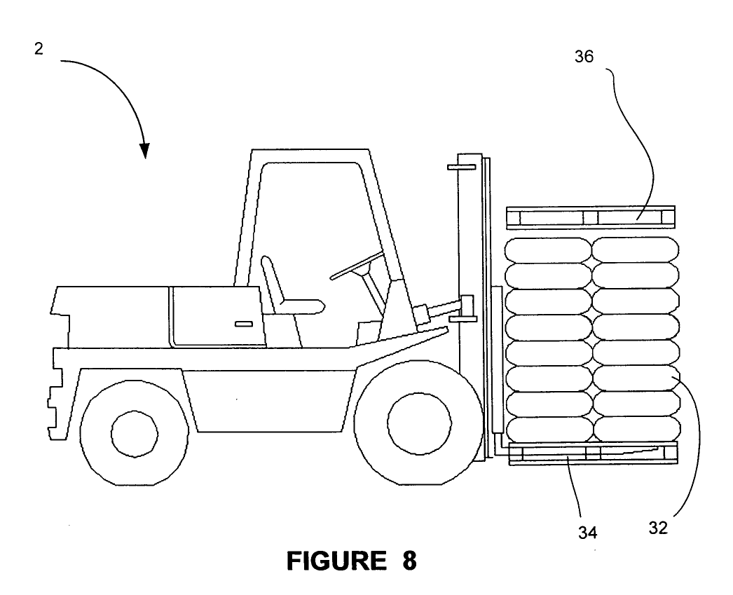

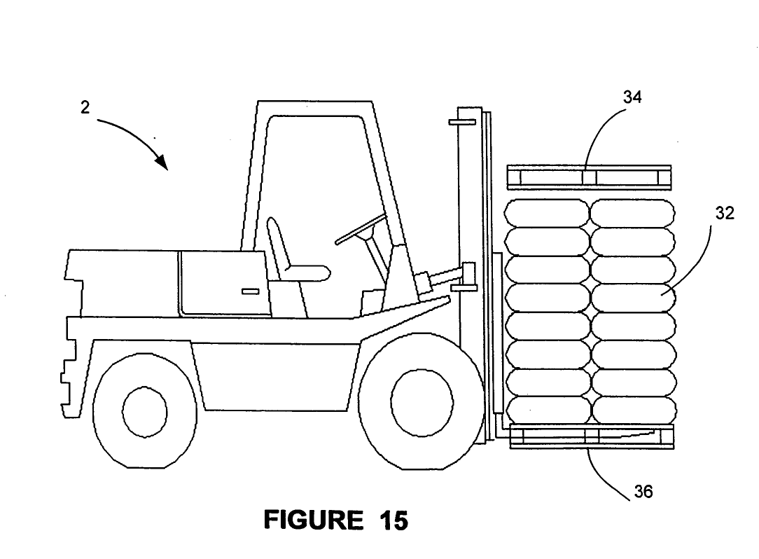

The further embodiment is to be described with reference to FIGS. 8 to 15. In FIG. 8 the forklift 2 is carrying a load 32 comprising a series of articles such as containers, packages, bags or boxes, supported on a first load support means 34 which is preferably in the form of a pallet and may be contaminated. A second load support means 36, which is uncontaminated and in the form of a pallet, may be transported on top of the load 32 or be located within frame 6 ready to be placed against the load 32.

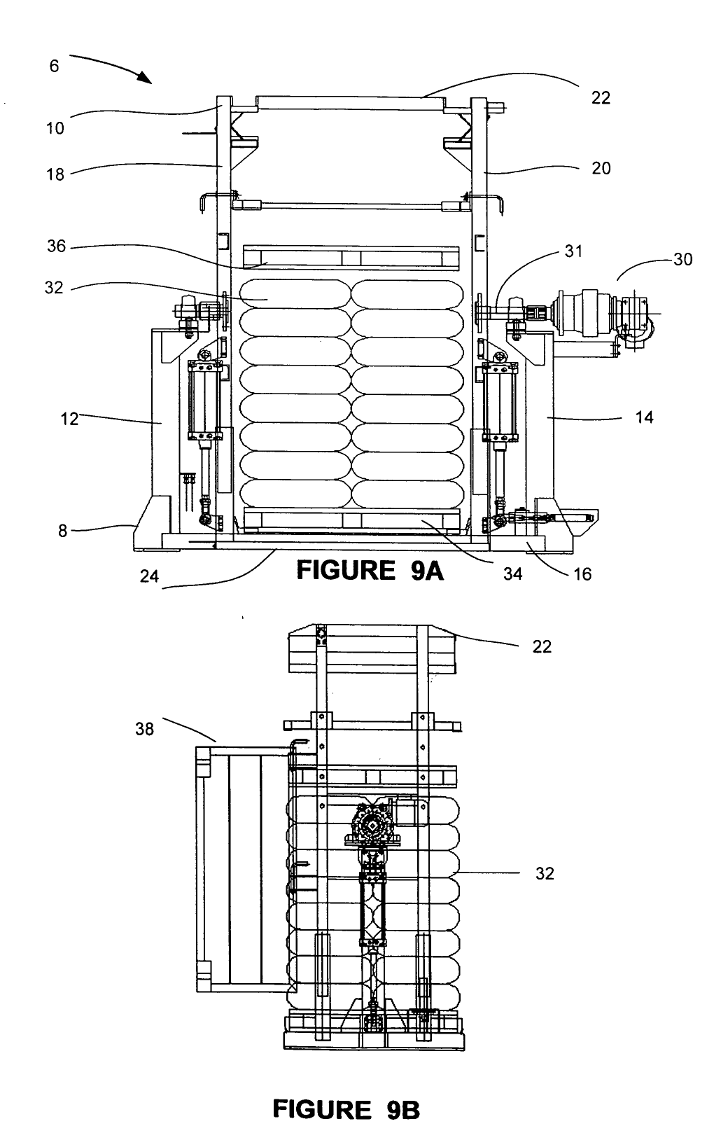

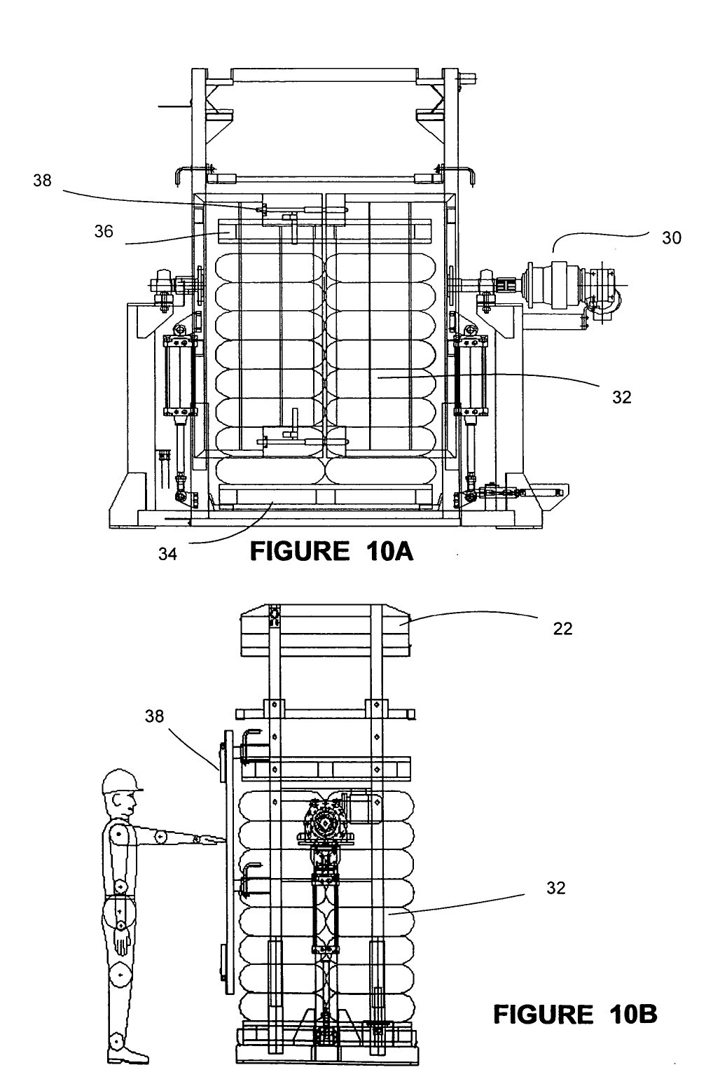

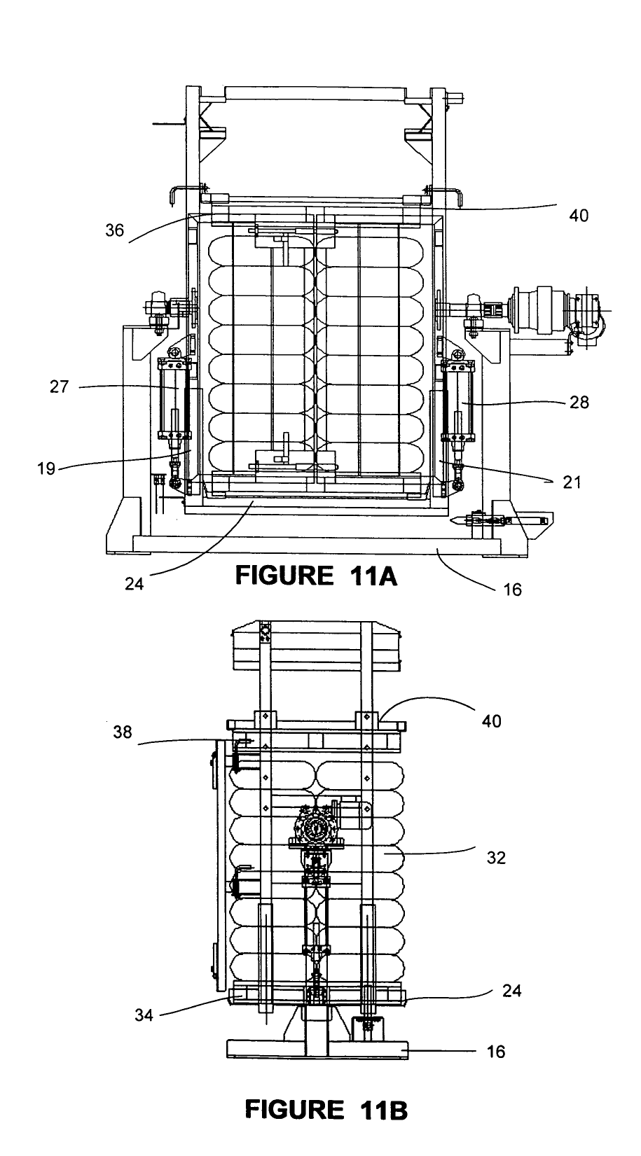

Referring to FIGS. 9A and 9B a gate 38 is opened to enable the forklift 2 to deposit the load 32 in the rotatable portion 10 of frame 6. Once the forklift has deposited the load 32 within the frame 6 an operator closes the gate 38 as shown in FIG. 10B. With reference to FIGS. 11A and 11B, air cylinders 27 and 28 are actuated to move sleeves 19 and 21 over the side members 18 and 20 respectively in order to move the bottom portion 24, on which is supported the load 32 and pallet 34, towards a clamping means 40 preferably in the form of a table. Once the second load support means or pallet 34 comes into contact with the table 40 (where the pallet 34 is not already attached to the table 40), the air cylinders 27 and 28 are deactivated and the table 40 is then clamped to the pallet 34. Thus the rotatable portion 10 is ready to be rotated with the load 32 and each of the pallets 34 and 36 securely fitted between the table 40 and the bottom member 24.

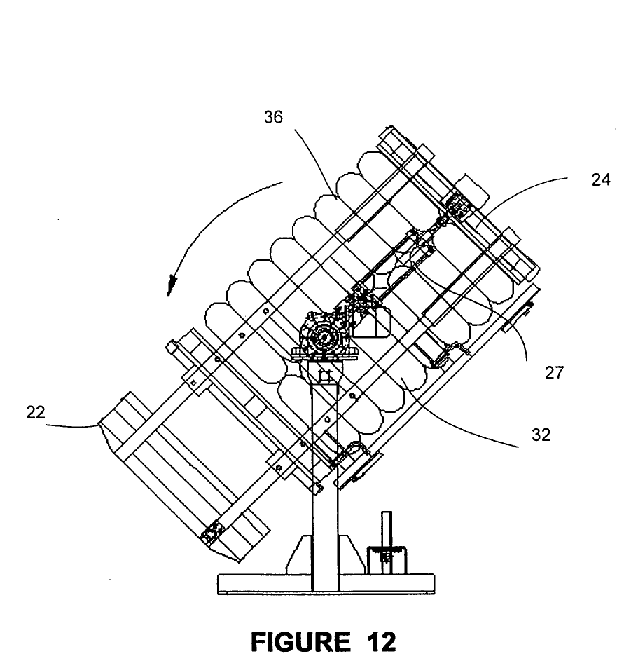

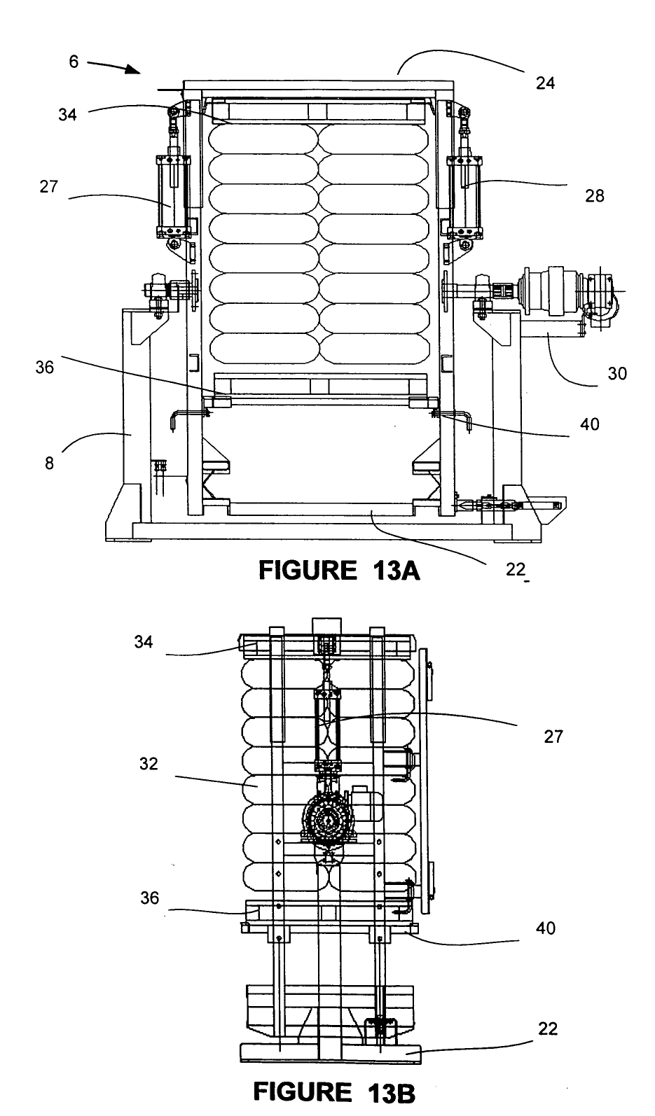

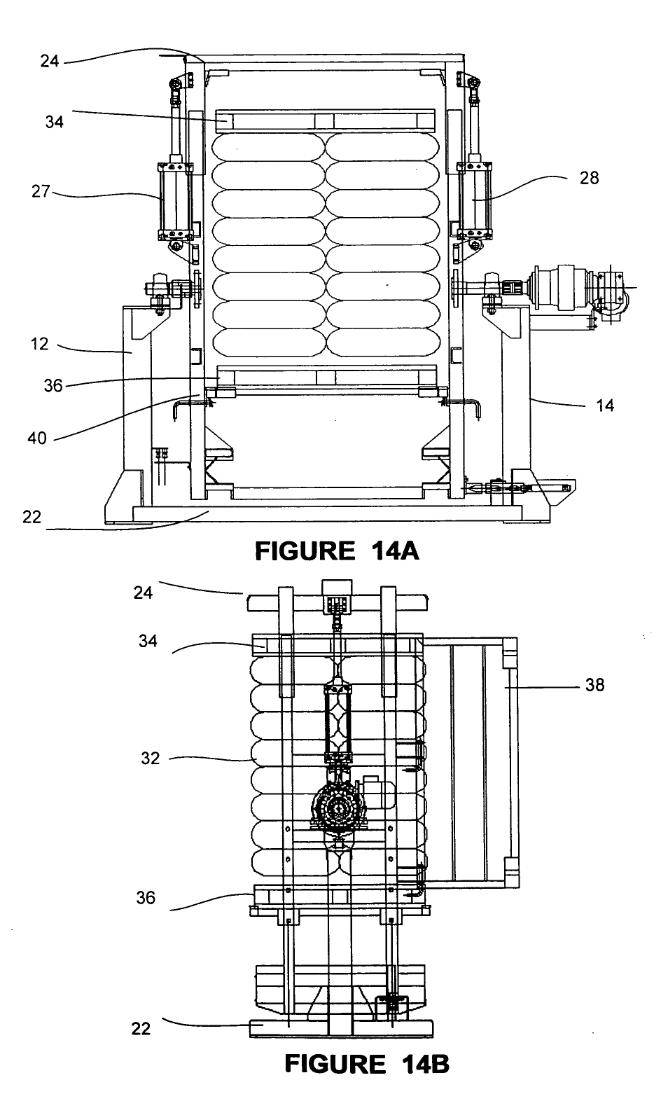

Referring to FIG. 12 the rotatable portion 10 is then rotated under the action of the motor 30 and shaft 31 previously described in relation to the first embodiment. In FIGS. 13A and 13B the rotatable portion 10 has been rotated 180° such that a top member 22 is now located at the bottom within base portion 8 whilst the bottom member 24 is now located at a top position of the frame 6. With reference to FIGS. 14A and 14B the air cylinders 27 and 28 are, actuated in a reverse manner such that they detach the contaminated pallet 34 from the bottom member 24 which is pushed upwardly by the action of the air cylinders 27 and 28. In FIG. 14B the gate 38 is opened by an operator, the pallet is then detached from table 40 which thereafter enables the forklift 2 to have its tines inserted into the gaps of uncontaminated pallet 36 and remove the load 32 from the frame 6 ready for transportation to another area such as an uncontaminated area. The contaminated pallet 34 is then removed prior to entry into the uncontaminated area for disposal or other uses. This leaves the new uncontaminated pallet 36 and load 32 ready for carting or transporting by the forklift 2 into a region that is free of contamination such as a pharmaceutical or food preparation or processing area.

It is to be noted that in either of the abovedescribed embodiments, a reverse process of rotating a load can be undertaken where the load is to be transferred from an uncontaminated pallet to a contaminated pallet, or where a container (with or without contents) and feed cone needs to be rotated to its original position.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of preparing for the unloading of contents of a container comprising the steps of:
attaching one end of a funnel means to an opening of the container, the funnel means having valve means located adjacent an opposite end of the funnel means;
rotating the funnel means and container through a predetermined angle using a frame; and
removing the funnel means and container from the frame ready for partial or full discharge of the contents through the funnel means and valve means.

2. A method according to claim 1 wherein the step of attaching the funnel means to the container comprises the step of clamping the periphery of the one end of the fumnel means to the opening of the container.

3. A method according to claim 2 wherein the step of clamping the periphery of the one end of the funnel means to the opening of the container comprises clamping the one end to a lip around the periphery of the opening of the container.

4. A method according to claim 3 wherein prior to the attaching step the method further comprises the step of raising the container to a position such that the opening of the container contacts the one end of the funnel means.

5. A method according to claim 4 wherein the rotating step results from the attachment or engagement of a shaft to a portion of the frame and the shaft driven by a motor so as to rotate the frame and container.

6. A method according to claim 5 further comprising the step of detaching the container from the frame after the funnel means and container have rotated through the predetermined angle.

7. A method according to claim 1 wherein the predetermined angle is about 180 degrees.

8. Apparatus for preparing for the unloading of contents of a container comprising:
a frame for receiving the container;
a funnel means having an end for attachment to an opening of the container, the funnel means having valve means located adjacent an opposite end of the funnel means;
whereupon securing the funnel means and container to the frame, a portion of the frame is able to rotate the funnel means and container through a predetermined angle to place the funnel means and container in a position ready for partial or full discharge of the contents through the funnel means and valve means.

9. Apparatus according to claim 8 wherein the frame comprises a base portion and a rotatable portion that rotates within the base portion.

10. Apparatus according to claim 9 wherein the container is initially loaded into the rotatable portion of the frame in a position below the end of the funnel means, said funnel means attached to a first member of the rotatable portion.

11. Apparatus according to claim 10 further comprising means for raising the container such that the opening of the container contacts the end of the funnel means.

12. Apparatus according to claim 11 wherein the raising means is a pair of cylinders.

13. Apparatus according to claim 12 wherein each cylinder in the pair of cylinders is a pneumatic cylinder.

14. Apparatus according to claim 13 wherein each cylinder in the pair of cylinders is attached to the rotatable portion of the frame.

15. Apparatus according to claim 14 further comprising means for attaching the funnel means to the opening of the container.

16. Apparatus according to claim 15 wherein the means for attaching comprises a series of clamps located adjacent the periphery of the end of the funnel means attachable to a lip around the periphery of the opening of the container.

17. Apparatus according to claim 16 further comprising a motor attached to the base portion to drive a shaft having a distal end connected to the rotatable portion of the frame in order to rotate the rotatable portion of the frame and thereby rotate the funnel means and container.

18. Apparatus according to claim 17 whereupon the funnel means and container have rotated through the predetermined angle the raising means is activated to release the container from the rotatable portion of the frame.

19. Apparatus according to claim 8 wherein the predetermined angle is about 180 degrees.

20. Apparatus according to claim 18 wherein the container is removed from the frame and transported for storage or to a processing station ready for removal of part or all of the contents of the container.

21. Apparatus according to claim 8 wherein the funnel means is substantially a truncated cone.

22. A method of rotating a load, positioned on a first load support means, comprising the steps of:
placing the load into a frame;
securing the load to a second load support means;
rotating a portion of the frame through a predetermined angle such that the second load support means fully supports the load;
removing the load and second load support means from the frame ready for transport to an uncontaminated environment; and
wherein the first load support means is prevented from entering the uncontaminated environment.

23. A method according to claim 22 wherein the step of securing the load to the second load support means comprises the step of clamping a portion of the load to the second load support means.

24. A method according to claim 23 further comprising the step of raising the load to a position such that the second load support means contacts a clamping means housed within the frame.

25. A method according to claim 24 further comprising the step of clamping the second load support means to the clamping means.

26. A method according to claim 22 wherein the securing step comprises clamping the portion of the load to the second load support means and securing the second load support means to a clamping means housed within the frame.

27. A method according to claim 26 further comprising the step of raising the load and second load support means prior to securing the second load support means to the clamping means.

28. A method according to claim 22 further comprising the steps of clamping the second load support means to a clamping means and raising the load to a position such that the portion of the load contacts the second load support means prior to the second load support means being secured to the load.

29. A method according to claim 28 wherein the rotating step results from the attachment or engagement of a shaft to a portion of the frame and the shaft driven by a motor so as to rotate the frame and load.

30. Apparatus for rotating a load, positioned on a first load support means, comprising:
a frame for receiving the load and the first load support means;
wherein a second load support means is secured to the load;
wherein further a portion of the frame is able to rotate through a predetermined angle until the second load support means fully supports the load;
wherein subsequently the load and second load support means are removed from the frame ready for transport to an uncontaminated environment and the first load support means is prevented from entering the uncontaminated environment.

31. Apparatus according to claim 30 wherein the second load support means is attached to the frame.

32. Apparatus according to claim 31 wherein the second load support means is attached to a clamping means housed within the frame.

33. Apparatus according to claim 32 wherein the frame comprises a base portion and a rotatable portion that rotates within the base portion.

34. Apparatus according to claim 33 wherein the load is initially loaded into the rotatable portion of the frame in a position below the second load support means, said second load support means attached to the clamping means housed within the rotatable portion.

35. Apparatus according to claim 34 further comprising means for raising the load such that a portion of the load contacts the second load support means and thereafter the second load support means is attached to the load.

36. Apparatus according to claim 30 wherein the second load support means is secured to the load either prior to placing the load in the frame or when the load has been placed in the frame.

37. Apparatus according to claim 36 wherein the second load support means is attached to a clamping means housed within the frame.

38. Apparatus according to claim 37 wherein the frame comprises a base portion and a rotatable portion that rotates within the base portion.

39. Apparatus according to claim 38 wherein the load is initially loaded into the rotatable portion of the frame, said second load support means attached to the clamping means housed within the rotatable portion.

40. Apparatus according to claim 39 further comprising means for raising the load wherein the second load support means is attached to the clamping means after raising the load by the raising means to enable the second load support means to make contact with the clamping means.

41. Apparatus according to claim 40 wherein the raising means is a pair of cylinders.

42. Apparatus according to claim 41 wherein each cylinder in the pair of cylinders is a pneumatic cylinder.

43. Apparatus according to claim 42 wherein each cylinder in the pair of cylinders is attached to the rotatable portion of the frame.

44. Apparatus according to claim 43 further comprising a motor attached to the base portion to drive a shaft having a distal end connected to the rotatable portion of the frame in order to rotate the rotatable portion of the frame and thereby rotate the load.

45. Apparatus according to claim 44 whereupon the load has rotated through the predetermined angle the raising means is activated to release the load and first load support means from the rotatable portion of the frame.

46. Apparatus according to claim 45 wherein the first load support means is subsequently removed from the load and frame.

47. Apparatus according to claim 30 wherein the predetermined angle is about 180 degrees.

48. Apparatus according to claim 30 wherein the first and second load support means are pallets.
